(19) United States
(12) Patent Application Publication
(10) Pub. No.: US 2003/0132839 A1
(43) Pub. Date: Jul. 17, 2003

(54) On-site local area security systems and methods

(75) Inventor: Jan Jansco, Johnston City, IL (US)

Correspondence Address: BROOKS & KUSHMAN, 1000 TOWN CENTER 22ND FL, SOUTHFIELD, MI, 48075

(73) Assignee: Security Consultants International, Ltd., West Bloomfield, MI (US)

(21) Appl. No.: 10/050,367

(22) Filed: Jan. 16, 2002

(51) Int. Cl. G08B 29/00

(52) U.S. Cl. 340/506; 340/531

(57) ABSTRACT

On-site local areas security systems and methods utilize an on-site paging unit. A system includes a plurality alarm devices, an alarm panel, an on-site paging unit, and at least one pager. The alarm panel receives an alarm signal from an alarm device and sends a second alarm signal that is received by the on-site paging unit. In response to receiving the second alarm signal, the on-site paging unit locally transmits an alarm message. The pagers receive the alarm message from the paging unit to notify the local security personnel of the alarm situation.

### BACKGROUND OF THE INVENTION

1. Field of the Invention

The present invention relates to on-site local area security systems and methods.

2. Background Art

An existing on-site local area security system includes a number of alarm devices and an alarm panel. Generally, either predetermined alarm conditions or personnel trigger one of the alarm devices, and the alarm device transmits a signal to the alarm panel. The alarm panel relays the alarm signal to a remote monitoring center by either telephone or satellite links. The remote monitoring center or central station processes the received signal, and sends an alarm notification signal to notify local security personnel or trigger the appropriate alarm response (for example, notify local authorities).

On-site security systems wherein the alarm panel relays an alarm signal to the central station via telephone or satellite communication are well known in the art. These existing systems, when attempting to notify local security personnel of the alarm situation, may also utilize telephone or satellite links to manually send an alarm notification from the central station to pagers resulting in a delay of several minutes between the initial alarm triggering and eventual notification receipt by the pagers. The several minute delay is a disadvantage associated with these existing systems. Response time is critical to efficient handling of any alarm situation. Also, misinterpretation or error in manually relaying information from the monitoring center could cause delayed or even improper response to the alarm condition and confusion at the site of an alarm situation.

For the foregoing reasons, there is a need for on-site local area security systems and methods that have a faster response time than existing systems.

### SUMMARY OF THE INVENTION

It is, therefore, an object of the present invention to provide on-site local area security systems and methods that utilize an on-site paging unit to locally transmit an alarm message resulting in reduced response time.

In carrying out the above object, an on-site local area security system for transmitting alarm messages to notify local security personnel of an alarm situation is provided. The system comprises a plurality of alarm devices, an alarm panel, an on-site paging unit, and at least one pager. Each alarm device is located on-site about the local area for transmitting a first alarm signal indicative of an alarm situation that occurs on-site within the local area. The alarm panel receives the first alarm signal and, in response to receiving the first alarm signal, sends a second alarm signal. The on-site paging unit receives the second alarm signal and, in response to receiving the second alarm signal, locally transmits an alarm message. The at least one pager receives the alarm message from the paging unit to notify the local security personnel of the alarm situation.

Advantageously, pagers receive the alarm message directly from the on-site paging unit eliminating the several minute delay normally associated with existing systems. In a preferred security system, at least one alarm device is a wireless communication device. That is, alarm devices that send signals to the alarm panel may take many forms. Preferably, the alarm panel has a data bus and the paging unit has an interface module connected to the data bus of the alarm panel. More preferably, the alarm message is an alpha-numeric alarm message, and the at least one pager is a wireless communication device having alpha-numeric output to display the alarm message.

In some embodiments, the alarm panel is further operative to send the second alarm signal to a monitoring company. That is, the alarm panel sends the signal to the monitoring company while also sending the signal to the on-site paging unit. That is, the alarm system reports to the central station or monitoring company, and the situation is also reported directly to security personnel who need to handle the situation by the on-site paging unit. The alarm panel may have a display and be operative to display the alarm message that is also displayed on the pagers.

Further, in carrying out the present invention, a retrofit system for an on-site local area security system for transmitting alarm messages to notify local personnel of an alarm situation is provided. The security system has a plurality of alarm devices with each alarm device located on-site about the local area for transmitting a first alarm signal indicative of an alarm situation that occurs on-site within a local area. The security system further has an alarm panel for receiving the first alarm signal and, in response to receiving the first alarm signal, sending a second alarm signal. The retrofit system comprises an on-site paging unit and at least one pager. The on-site paging unit is configured with an interface module for receiving the second alarm signal. In response to receiving the second alarm signal, the on-site paging unit locally transmits an alarm message. The at least one pager receives the alarm message from the on-site paging unit to notify local security personnel of the alarm situation.

The retrofit system may incorporate any number of preferred features discussed above for the on-site local area security system. The retrofit system is advantageous in that an existing system may be retrofitted with an on-site paging unit and at least one pager to provide advantages of the present invention while utilizing existing infrastructure.

Further, in carrying out the present invention, an on-site local area security method for transmitting alarm messages to notify local security personnel of an alarm situation is provided. The method comprises transmitting a first alarm signal indicative of an alarm situation that occurs on-site within the local area. The method further comprises receiving the first alarm signal at the alarm panel, and in response to receiving the first alarm signal, sending a second alarm signal from the alarm panel. The second alarm signal is receiving at an on-site paging unit. In response to receiving the second alarm signal, an alarm message is locally transmitted from the on-site paging unit. The alarm message is received from the paging unit with at least one pager to notify the local security personnel of the alarm situation.

The second alarm signal may also be sent from the alarm panel to a monitoring company. Further, the alarm message may also be displayed at the alarm panel.

Still further, in carrying out the present invention, a retrofitting method for use with an on-site local area security system for transmitting alarm messages to notify local personnel of an alarm situation is provided. The security system has a plurality of alarm devices. Each alarm device is located on-site about the local area for transmitting a first alarm signal indicative of an alarm situation that occurs on-site within the local area. The security system further has an alarm panel for receiving the first alarm signal and, in response to receiving the first alarm signal, sending a second alarm signal. The retrofit method comprises installing an on-site paging unit configured with an interface module for receiving the second alarm signal. In response to receiving the second alarm signal, the on-site paging unit locally transmits an alarm message.

Preferred methods further comprise providing at least one pager for receiving the alarm message from the on-site paging unit to notify the security personnel of the alarm situation. In a preferred embodiment, installing further comprises connecting the paging unit interface module to a data bus of the alarm panel.

Advantages associated with embodiments of the present invention are numerous. For example, embodiments of the present invention provide an on-site paging system integrated with an alarm system. Embodiments of the present invention include a complete on-site local area security system, a retrofit system, as well as an on-site local area security method and a retrofitting method. In the event of an alarm, the alarm panel receives a signal, sends a signal to its display (if present) while simultaneously sending the signal to an interface to the paging unit. The paging unit sends a signal to one or more pagers with the alarm panel optionally sending a signal to a monitoring company. Advantageously, the time frame between the receipt by the alarm panel of notification of the alarm situation and notification at the pagers is far shorter than the several minute delay associated with some existing systems.

The above object and other objects, features, and advantages of the present invention are readily apparent from the following detailed description of the preferred embodiment when taken in connection with the accompanying drawings.

### BRIEF DESCRIPTION OF THE DRAWINGS

FIG. 1 illustrates an on-site local area security system of the present invention;

FIG. 2 illustrates an on-site local area security method of the present invention; and

FIG. 3 illustrates a retrofitting method of the present invention.

### DETAILED DESCRIPTION OF THE PREFERRED EMBODIMENTS

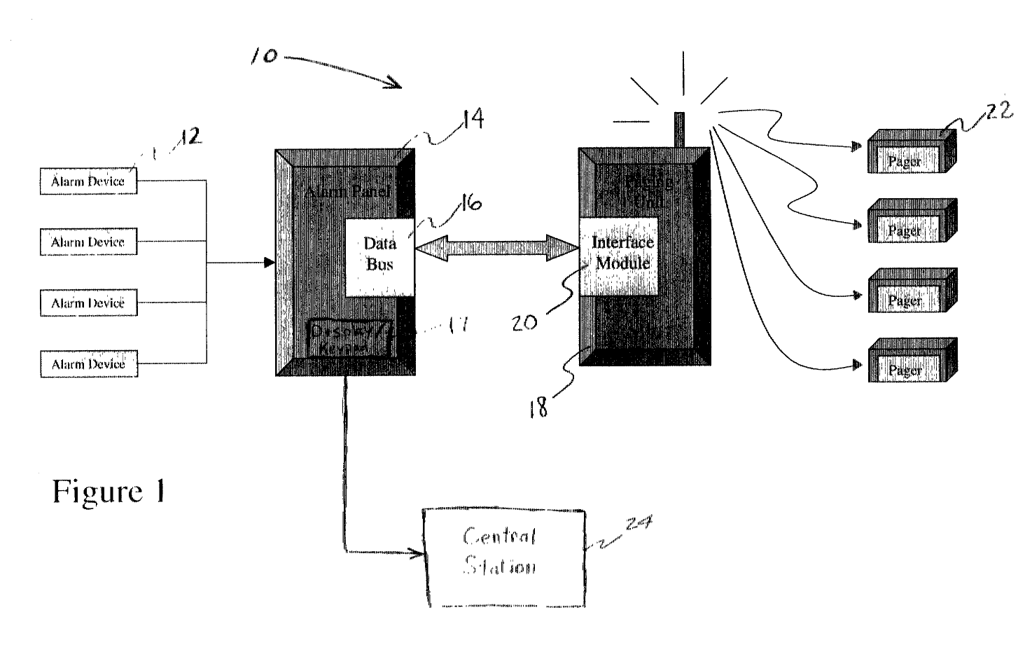

FIG. 1 illustrates an on-site local area security system at 10. System 10 includes a plurality of alarm devices 12 and an alarm panel 14. Each alarm device 12 is located on-site about the local area for transmitting a first alarm signal indicative of an alarm situation that occurs on-site within the local area. The alarm devices may be hard wired or wirelessly connected to alarm panel 14. Alarm panel 14 includes internal data bus 16 and optionally includes display/keypad 17. Typically, upon notification of an alarm situation, alarm panel 14 displays information at display/keypad 17. In accordance with the present invention, the paging unit 18 includes an interface module 20 connected to data bus 16. Alarm panel 14, upon receiving the alarm signal from one of the alarm devices 12, sends an alarm signal to on-site paging unit 18. On-site paging unit 18 locally transmits an alarm message received by pagers 22. The pagers 22 receive the alarm message from paging unit 18 to notify the local security personnel of the alarm situation.

Specifically, embodiments of the present invention provide an on-site paging system integrated with an alarm system. Alarm panel 14, with alpha software capability, is connected to on-site paging system 18 or any suitable paging unit by interface module 20 connected to data bus 16. In the event of an alarm, alarm panel 14 receives a signal from an alarm device 12 and in turn sends it immediately to its display/keypad 17. Simultaneously, alarm panel 14 sends the signal through interface 20 to paging unit 18. Paging unit 18 then sends the signal to pagers 22 that are worn by security personnel or other key personnel. The time frame to the pagers is almost instantaneous. Embodiments of the present invention are advantageous in that immediate notification of events or alarms is provided. As such, key personnel are able to handle an event or alarm with speed and efficiency and are not subject to the several minute delay associated with existing telephone and satellite link systems where the monitoring company sends the signals to the pagers.

It is appreciated that the present invention comprehends preferred on-site local security system 10 as well as a retrofit system. The retrofit system is installed when alarm devices 12 and alarm panel 14 are already present. In retrofitting, paging unit 18 with interface module 20 is arranged to communicate with data bus 16 of alarm panel 14. Paging unit 18 in turn is configured to communicate with pagers 22. That is, in accordance with the present invention, a paging unit and pagers may be provided to an existing alarm panel 14. Alarm panel 14 may continue to function in its normal way by sending alarm notifications to, for example, display/keypad 17 and to central station 24; the paging unit 18 receives alarm notification at interface module 20 from data bus 16 and in turn notifies pagers 22.

Preferred embodiments of the present invention advantageously provide immediate on-site notification of an alarm situation to a person without the person having to be in front of display/keypad 17 or having to be radioed from central station 24. Having pagers 22 on key personnel provide key personnel with the same information that has transmitted to central station 24.

Embodiments of the present invention are suitable for many applications. For example, a number of personnel using the system and carrying pagers may all converge on a situation at the same time. For example, in a school application, a school teacher may press a panic button and a hall monitor receives the information and can respond immediately without having to be radioed. Alarm cancel signals may also be sent over the paging system. In another example, a guard at an embassy, factory, company, or office complex, can respond faster to an alarm situation. In another example, a gate attendant at an airport can press a panic button and local security immediately receives the alarm signal. In addition, connecting interface module 20 to data bus 16 assures that correct information is transmitted to pagers 22.

As shown in FIG. 1, interface module 20 hooks directly to the data bus 16 of alarm panel 14. It is appreciated that this connection may be a direct cable connection or a wireless connection. Advantageously, the same message displayed at display/keypad 17 is displayed on pagers 22.

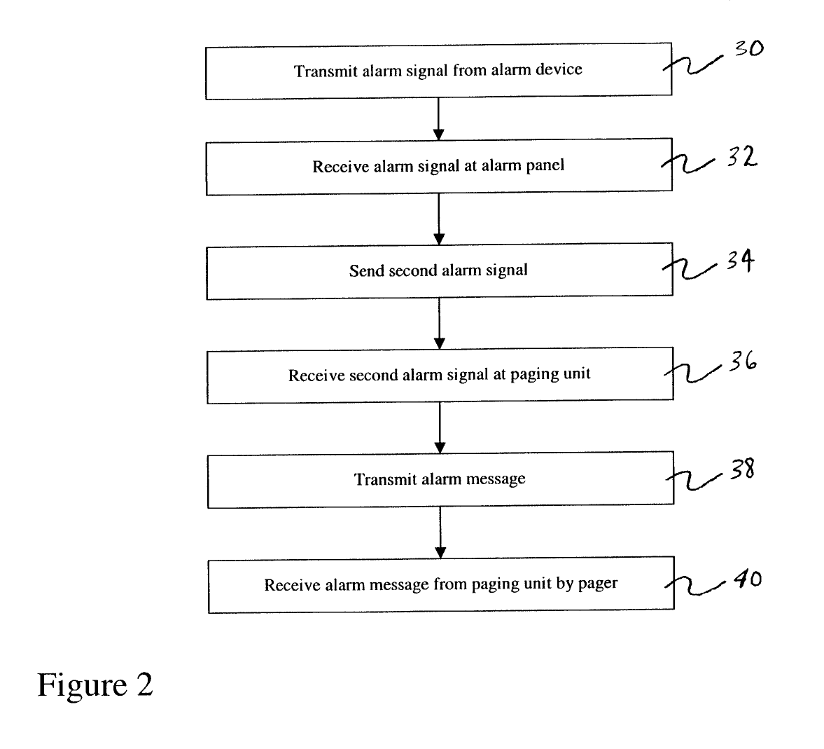

FIG. 2 illustrates an on-site local area security method for transmitting alarm messages to notify local security personnel of an alarm situation. At block 30, a first alarm signal indicative of an alarm situation that occurs on-site within a local area is transmitted from the alarm device. At block 32, the first alarm signal is received at the alarm panel. At block 34, in response to receiving the first alarm signal, a second alarm signal is sent from the alarm panel. At block 36, the second alarm signal is received at the on-site paging unit. At block 38, in response to receiving the second alarm signal, the on-site paging unit locally transmits an alarm message. At block 40, the alarm message is received from the paging unit by one or more pagers to notify local security personnel of the alarm situation. It is appreciated that the alarm signal may also be sent to a monitoring company or central station by the alarm panel. Further, the alarm message may also be displayed at the alarm panel display/keypad in addition to at the pagers.

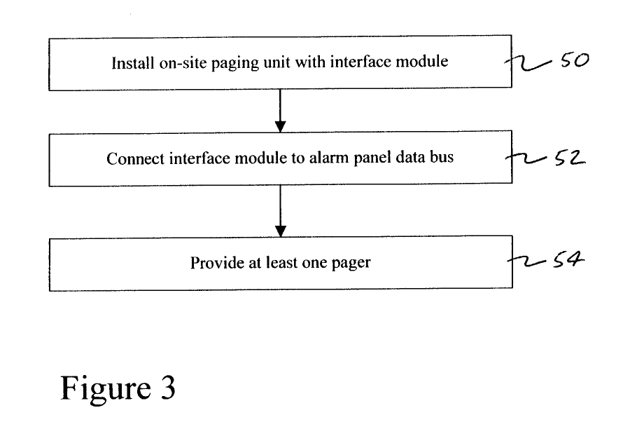

FIG. 3 illustrates a retrofitting method for use with an on-site local area security system for transmitting alarm messages to notify local personnel of an alarm situation. At block 50, an on-site paging unit with an interface module is installed. Specifically, the on-site paging unit is configured with an interface module to receiving an alarm signal from the data bus of the alarm panel. In response for receiving the alarm signal, the on-site paging unit locally transmits an alarm message. In preferred retrofit methods, the interface module is connected to the existing alarm panel data bus (block 52) and at least one pager is provided (block 54).

While embodiments of the invention have been illustrated and described, it is not intended that these embodiments illustrate and describe all possible forms of the invention. Rather, the words used in the specification are words of description rather than limitation, and it is understood that various changes may be made without departing from the spirit and scope of the invention.

What is claimed is:

1. An on-site local area security system for transmitting alarm messages to notify local security personnel of an alarm situation, the system comprising:
a plurality of alarm devices, each alarm device located on-site about the local area for transmitting a first alarm signal indicative of an alarm situation that occurs on-site within the local area;
an alarm panel for receiving the first alarm signal and, in response to receiving the first alarm signal, sending a second alarm signal;
an on-site paging unit for receiving the second alarm signal and, in response to receiving the second alarm signal, locally transmitting an alarm message; and
at least one pager for receiving the alarm message from the paging unit to notify the local security personnel of the alarm situation.

2. The security system of claim 1 wherein at least one alarm device is a wireless communication device.

3. The security system of claim 1 wherein the alarm panel has a data bus and wherein the paging unit has an interface module connected to the data bus of the alarm panel.

4. The security system of claim 1 wherein the alarm message is an alpha-numeric alarm message.

5. The security system of claim 4 wherein the at least one pager is a wireless communication device having alpha-numeric output to display the alarm message.

6. The security system of claim 1 wherein the alarm panel is operative to send the second alarm signal to a monitoring company.

7. The security system of claim 6 wherein the alarm panel has a display and is further operative to display the alarm message.

8. A retrofit system for an on-site local area security system for transmitting alarm messages to notify local personnel of an alarm situation, the security system having a plurality of alarm devices, each alarm device located on-site about the local area for transmitting a first alarm signal indicative of an alarm situation that occurs on-site within the local area, the security system further having an alarm panel for receiving the first alarm signal and, in response to receiving the first alarm signal, sending a second alarm signal, a retrofit system comprising:
an on-site paging unit configured with an interface module for receiving the second alarm signal, and in response to receiving the second alarm signal, locally transmitting an alarm message; and
at least one pager for receiving the alarm message from the on-site paging unit to notify the local security personnel of the alarm situation.

9. The retrofit system of claim 8 wherein the alarm panel has a data bus and wherein the paging unit interface module is connected to the data bus of the alarm panel.

10. The retrofit system of claim 8 wherein the alarm message is an alpha-numeric alarm message.

11. The retrofit system of claim 10 wherein the at least one pager is a wireless communication device having alpha-numeric output to display the alarm message.

12. The retrofit system of claim 8 wherein the alarm panel is operative to send the second alarm signal to a monitoring company.

13. The retrofit system of claim 12 wherein the alarm panel has a display and is further operative to display the alarm message.

14. An on-site local area security method for transmitting alarm messages to notify local security personnel of an alarm situation, the method comprising:
transmitting a first alarm signal indicative of an alarm situation that occurs on-site within the local area;
receiving the first alarm signal at an alarm panel;
in response to receiving the first alarm signal, sending a second alarm signal from the alarm panel;
receiving the second alarm signal at an on-site paging unit;
in response to receiving the second alarm signal, locally transmitting an alarm message from the on-site paging unit; and
receiving the alarm message from the paging unit with at least one pager to notify the local security personnel of the alarm situation.

15. The security method of claim 14 further comprising:
sending the second alarm signal from the alarm panel to a monitoring company.

16. The security method of claim 19 further comprising:
displaying the alarm message at the alarm panel.

17. A retrofitting method for use with an on-site local area security system for transmitting alarm messages to notify local personnel of an alarm situation, the security system having a plurality of alarm devices, each alarm device located on-site about the local area for transmitting a first alarm signal indicative of an alarm situation that occurs on-site within the local area, the security system further having an alarm panel for receiving the first alarm signal and, in response to receiving the first alarm signal, sending a second alarm signal, the retrofit method comprising:
installing an on-site paging unit configured with an interface module for receiving the second alarm signal, and in response to receiving the second alarm signal, locally transmitting an alarm message.

18. The method of claim 17 further comprising:
providing at least one pager for receiving the alarm message from the on-site paging unit to notify the local security personnel of the alarm situation.

19. The method of claim 17 wherein the alarm panel has a data bus, and wherein installing further comprises:
connecting the paging unit interface module to the data bus of the alarm panel.
